(19) United States
(12) Patent Application Publication
(10) Pub. No.: US 2025/0202313 A1
(43) Pub. Date: Jun. 19, 2025

(54) ELECTRIC MOTOR WITH COOLING COMPONENT

(71) Applicant: TEXA DYNAMICS S.R.L., Monastier di Treviso (IT)

(72) Inventors: Bruno VIANELLO, Monastier di Treviso (IT); Massimiliano GIACOMETTI, Monastier di Treviso (IT)

(21) Appl. No.: 18/847,304

(22) PCT Filed: Mar. 5, 2023
(86) PCT No.: PCT/IB2023/052048

§ 371 Date: Sep. 16, 2024

(30) Foreign Application Priority Data
Mar. 16, 2022 (IT) 102022000005192

(51) Int. Cl. H02K 5/20

(52) U.S. Cl. CPC H02K 5/20

(57) ABSTRACT

An electric motor (MC) comprising a rotor rotating about a rotation axis and a stator having windings placed along a stator circumference, is described. A cooling component has a cooling surface extending in a plane perpendicular to said axis to cover at least one circular crown or arc of circular crown of the stator circumference equal to substantially at least ¼ or ⅓ or ½ of the area circumscribed by the stator circumference.

### TECHNICAL FIELD

The present invention relates to a cooling component for electric motor, and to the electric motor with such cooling component installed in it. Specifically, the electric motor is an axial-flux electric motor, and is taken as an example in the following. The present invention also relates to a vehicle (e.g. a car, truck, train, or ship) aboard which the motor is installed to propel the vehicle.

### BACKGROUND

Electric vehicles, especially high-performance vehicles, mount electric motors that dissipate a lot of heat (rated powers of hundreds of kW) to be disposed of. The motor's rotor, although it cools with rotation, also needs cooling, especially in an axial-flux motor. Ad hoc cooling systems have been designed for this purpose, see e.g. PCTIB2020057951 or US20180145574. PCTIB2020057951 describes a cooling system only for the central part of the rotor, while US20180145574 proposes air cooling generated by vanes applied to the rotor. In US20180145574, the heat dissipated cannot be recovered, and especially the cooling efficiency depends on the ambient temperature.

### SUMMARY

The main object . . .

The main object of the invention is to improve the present state of the art. The object is achieved by what is contained in the appended claims; and advantageous technical features are defined in the dependent claims.

An electric motor is proposed comprising:
a rotor rotatable about a rotation axis,
a stator equipped with windings placed along a circumference (referred to here as the “stator circumference”) about said axis, each winding for creating a magnetic field by which to set the rotor into rotation,
a circuit for circulating refrigerant fluid,
a cooling component having a cooling surface extending in a plane perpendicular to said axis for covering at least one circular crown or arc of circular crown of the stator circumference substantially equal to at least ¼ or ⅓ or ½ of the area circumscribed by the stator circumference,
wherein said cooling surface comprises at least one channel that
   is part of the circuit and
   comprises an inlet, from which it is supplied with refrigerant fluid circulating in the
   circuit, and an outlet, from which it discharges heated fluid into the circuit.

The cooling component implements a free, cooling surface. The free, cooling surface of the cooling component faces without contact directly the rotor, which is cooled by convection. The free, cooling surface of the cooling component cools the air around the rotor.

A circular crown is the portion of a circle contained between any two concentric circumferences. An arc of circular crown is a portion of a circular crown contained between an arc of circumference and the radii that have an endpoint at the extremes of the arc. A circular sector is the portion of a circle enclosed between an arc of circumference and the radii that have an endpoint at the extremes of the arc.

If the cooling component is applied to a motor with only one rotor, said cooling surface can also cover all or nearly all of the area circumscribed by the stator circumference because there is not the encumbrance of the outlet shaft. Then, in a variant said cooling surface of the component extends in a plane perpendicular to said axis to cover a circular sector of the stator circumference substantially equal to at least ¼ or ⅓ or ½ of the area circumscribed by the stator circumference. That is, the cooling surface comprises the portion around the axis.

In a variant of maximum simplicity, the cooling surface comprises only one channel but not necessarily (it depends for instance on the application).

In a variation a or each channel in the cooling surface extends from its respective inlet along a path that follows an arc of circumference of radius less than that of said stator circumference. The channel thus curved can make a kind of serpentine path and/or cover different and/or adjacent bands of the surface.

In a variant said inlet and outlet are arranged substantially on the stator circumference to simplify the connection to the circuit of cooling fluid. Specifically, a or each channel in the cooling surface comprises the sequence—or consists of the sequence—of:
a first segment extending from the respective inlet along a path that follows a first arc of circumference of radius less than that of said stator circumference,
a second segment that makes a U-turn,
a third segment extending from the second segment to its respective outlet along a path that follows a second arc of a circumference having a radius smaller than that of said circumference and different from the first arc.

According to a preferred easy-to-fabricate construction, the cooling component comprises two overlapping foils attached together hermetically and spanning a flat surface, the two foils being separated locally by a gap to form said channel, wherein in particular the gap is made by local expansion of one or each foil in a direction orthogonal to the laying plane of the other foil.

To facilitate assembly, the cooling component is preferably mounted on a connecting flange that comprises a circular attachment ring of substantially the same radius as that of said stator circumference. Thus the flange can be mounted around the perimeter of the stator; e.g., the motor comprises a housing that encloses the rotor and the stator, and the flange can be mounted around the perimeter of the housing.

To facilitate mounting an angular position sensor (resolver) to detect the angular position of the rotor, preferably the flange comprises a central portion integral with the circular ring configured to house a rotary encoder.

In the case of an axial-flux electric motor, the rotor is equipped with a circular array of magnetic elements placed around said axis, and the stator windings are configured to create a magnetic field with a polar axis parallel to the rotation axis; through the magnetic field, the rotor is set into rotation due to the magnetic interaction with the corresponding circular array of magnetic elements of the rotor.

The cooling component may also be applied to a motor with more than one rotor. E.g., the rotors are two and/or coaxial to and/or integral with a respective driving shaft exiting the motor from a direction opposite to another drive shaft. This is the case, e.g., of an electric motor moving a wheeled vehicle, wherein the motor comprises two independent drive shafts for two driving wheels.

The above single-rotor motor can then form a module for the vehicle's independent two-rotor electric motor. In this variant, the motor comprises:
two motor modules, each module comprising
a rotor and stator as defined above,
a drive shaft integral with the rotor,
   the rotor and stator of one module being coaxial to the rotor and stator of the other module, the drive shaft of one module being coaxial to the drive shaft of the other module and projecting from the motor in the opposite direction with respect to the other shaft,
a circuit for circulating refrigerant fluid,
a cooling component as defined above, mounted between and in contact with the two modules.

For example, the motor modules are equal to each other, and/or share the variants mentioned above for the single-rotor motor.

In the case of a first module coupled to a second module, wherein the first module is equipped with a first cooling component and the second module is equipped with a second cooling component, the first and second cooling components each have a cooling surface and a pass-through cavity. Preferably, the two said cooling surfaces are arranged angularly complementary about the rotation axis of the rotors, i.e., the two cooling surfaces lie substantially on the same plane or on parallel offset planes but do not overlap in the axial direction. That is, looking at the first and second components along the axis of the rotors, the cooling surfaces are disconnected, they have no common areas. This arrangement maximizes the thermal withdrawal capacity.

More preferably, the cooling surface of the cooling component of the first module is placed at the pass-through cavity of the cooling component of the second module, and vice versa.

In some variants there may be multiple channels starting from said inlet and arriving to said outlet. Or different channels may have independent inlets and outlets.

In some variants there may be channels, e.g. bulging channels, on both sides of the cooling component or only on one side.

Another aspect of the invention concerns a method for cooling a rotor of electric motor as defined above, with the steps of
cooling the rotor by convection through the passage of coolant fluid inside a component fixed on the stator and spaced away from the rotor, wherein the passage of coolant fluid occurs in a surface characterized as said cooling surface.

The method also shares all the variants defined here for the cooling surface, the cooling component, and the motor module.

### BRIEF DESCRIPTION OF THE DRAWINGS

Further advantages will become clear from the following description, which refers to an example of a preferred motor embodiment in which:

FIG. 1 shows a schematic side view of an electric motor with two independent shafts;

FIG. 2 shows a three-dimensional view of an electric motor module;

FIG. 3 shows in three-dimensional view a component of the module in FIG. 2;

FIGS. 4 and 5 show in three-dimensional view from different angles the component in FIG. 3.

### DETAILED DESCRIPTION

Equal numbers in the figures indicate equal or substantially equal parts. To avoid crowding the drawings, equal elements are not all numbered.

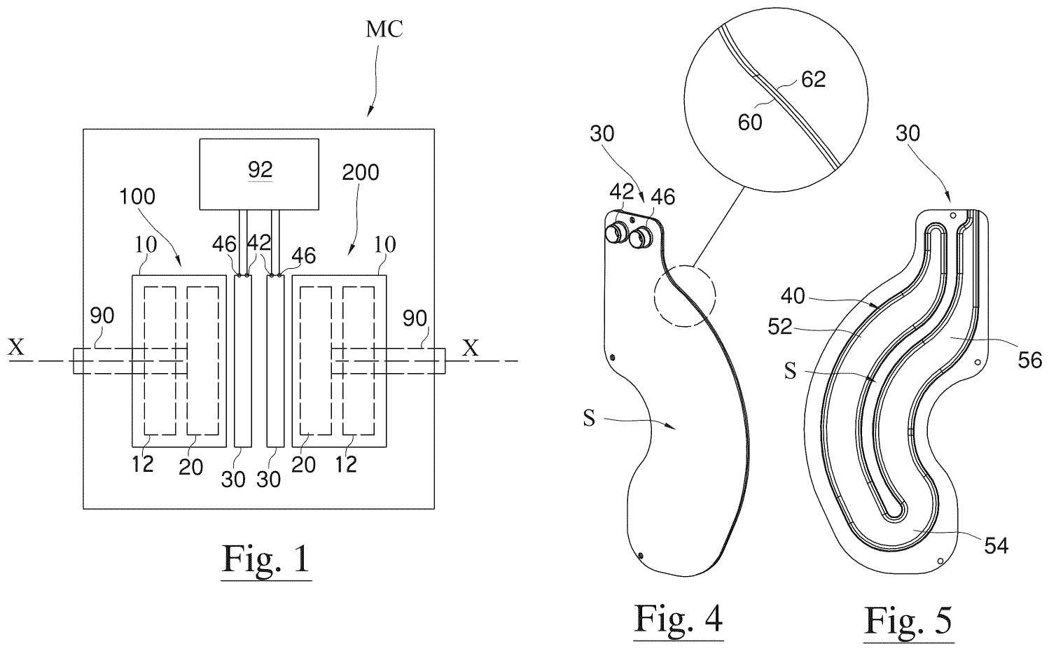

FIG. 1 shows an electric motor MC comprising two motor modules 100, 200 arranged side by side and coupled to each other. Each module 100, 200 comprises a casing 10 that contains both a known stator 12 and a known rotor 20 that can rotate about an rotation axis X. Each rotor 20 transmits rotary motion to a respective output shaft 90 that protrudes from the casing 10.

The motor MC preferably has polar symmetry around the X axis.

E.g., the motor modules 100, 200 are equal to each other.

The rotor 20 and the stator 12 of the module 100 are coaxial to the rotor 20 and the stator 12 of the other module 200. The drive shaft 90 of the module 100 is coaxial to the drive shaft 90 of the other module 200, each shaft 90 coming out of the respective casing 10 in opposite directions.

In the stator 12 there are known windings placed along an imaginary circumference C with center on the X axis, where each winding serves to create a magnetic field that, by interacting with magnets placed on the rotor 20, can set the rotor 20 into rotation.

On the casing 10 of each module 100, 200, on the side closest to the rotor 20, is mounted a cooling element 30 fed in closed circuit manner by a liquid-circulating cooling circuit 92 (e.g., a pump and liquid-conveying ducts).

The cooling component 30 is a substantially flat body having a major surface S extending in a plane perpendicular to the X axis.

The surface S in the example in FIG. 1 covers substantially at least ⅓ or ½ of the area circumscribed by the circumference C, and comprises a channel 40 for the flow of coolant liquid, and extends along an arc of circular crown.

The channel 40 has an inlet 42, from which it is supplied with refrigerant fluid from the circuit 92, and an outlet 46 from which it discharges heated fluid into the circuit 92.

In general, the area covered by the surface S, and/or the number of channels 40 and/or the development of each channel 40 made in it, may be different from what is illustrated.

In FIG. 1, the surface S integrates only one channel 40, having an inlet 42 and an outlet 46 arranged substantially on the circumference C. The channel 40 extends from the inlet 42 with a segment 52 following a first arc of circumference having radius less than that of the circumference C, followed by a U-shaped segment 54, followed by a segment 56 extending to the outlet 46 along a second arc of circumference having radius less than that of the circumference C and different from the first arc.

The cooling component in a preferred construction comprises two foils 60, 62 that are overlapped and attached together hermetically, and that extend in a plane to form the surface S. The two foils 60, 62 are separated locally by a gap forming a channel 40.

One can produce such cooling element 30 in various ways, e.g., by 3D printing or deep drawing. A preferred method involves depositing on a foil a material (e.g., a varnish) that locally prevents the joining of the foils 60, 62. The two foils 60, 62 are then attached by compression and temperature. Then with a pressure wave, the sandwich of attached foils 60, 62 is “inflated” causing at least one foil to lift and expand in correspondence of the deposited material. Between the two foils 60, 62 where one or each has lifted, a or the channel 40 is formed. Note that the outward bulging of one or each foil 60, 62 in correspondence of the channel 40 increases the active heat transfer surface towards the rotor.

In a variant, the cooling component 30 is mounted on a connecting flange 80. The flange 80 comprises a circular attachment ring 82 having substantially the same radius as that of the circumference C, so it can be mounted on the edge of the casing 10.

The flange 80 preferably comprises a central portion 84, integral with the circular ring 82 and coaxial to the X axis, configured to accommodate a rotary encoder 96 for the rotor 20.

To improve the mutual coupling between the two cooling components 30 of the motor MC and to improve heat exchange with their respective rotors 12, the surface S of a or each cooling component 30 covers at most a circular crown or arc of circular crown having an area at most equal to ½ or ⅓ of the area circumscribed by the circumference C. The area not covered by the surface S remains empty and corresponds to one or more pass-through openings or windows 76 in the thickness of the component 30 (e.g., in the flange 80). Each component 30 is installed at the pass-through openings or windows 76 of the other component 30, so that each component 30 can remove heat from the air passing through the pass-through openings or windows 76.

The one or more pass-through openings or windows 76 can be made in the thickness of the foils 60, 62 or in the flange 80, which then ends up having one or more radial spokes 78 that join to the ring 82.

Although it is possible to create a single component 30 that cools the whole surface when there are two rotors, it is preferred to use two components 30 so that the two motors each have a resolver. The two component 30 provide the corresponding supports for the resolver.

If the motor MC is an axial-flux motor, the rotor 20 is equipped with a circular array of magnetic elements around the X axis, and the windings of the stator 12 are configured to create a magnetic field, with polar axis parallel to the rotation axis X, by which to set the rotor 12 into rotation due to magnetic interaction with the corresponding circular array of magnetic elements of the rotor 12.

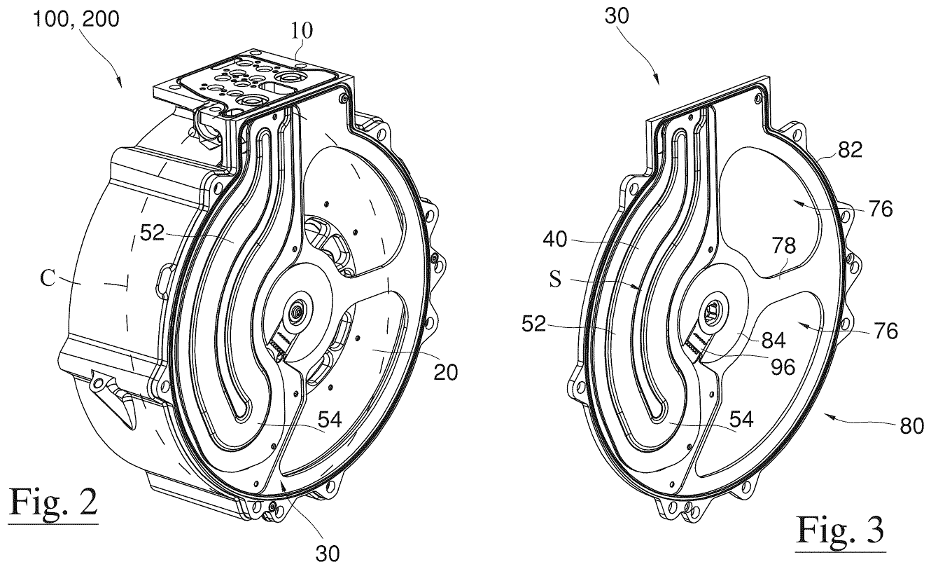

The cooling component can also be applied to a motor with a single rotor 12. This is the case, e.g., of an electric motor such as the module of FIG. 2 or such as the motor of FIG. 1 where only the module 100, the associated cooling element 30 and the circuit 92 are kept. In a single-rotor motor, the surface S can advantageously extend so far as to cover even the entire area circumscribed by the circumference C to improve heat transfer.

In different variants there may be multiple channels starting from the inlet 42 and arriving to the outlet 46. Or different channels may have independent inlets and outlets.

In different variants there can be channels, e.g., bulging channels, on both sides of the component 30.

1. Electric motor comprising:
a rotor rotatable about a rotation axis,
a stator provided with windings placed along a circumference, called here stator circumference, about said axis, each winding for creating a magnetic field by which to set the rotor into rotation,
a circuit for circulating refrigerant fluid,
a cooling component having a cooling surface extending in a plane perpendicular to said axis to cover at least one circular crown, or one arc of circular crown, of the stator circumference equal substantially to at least ¼ or ⅓ or ½ of the area circumscribed by the stator circumference,
wherein said cooling surface comprises at least one channel which
is part of the circuit and
comprises an inlet, from which it is supplied with refrigerant fluid circulating in the circuit, and an outlet, from which it discharges heated fluid into the circuit.

2. Motor according to claim 1, characterized by having only one rotor, and said cooling surface covers all or nearly all of the area circumscribed by the stator circumference.

3. Motor according to claim 2, wherein said cooling surface of the component extends in a plane perpendicular to said axis to cover a circular sector of the stator circumference substantially equal to at least ¼ or ⅓ or ½ of the area circumscribed by the stator circumference.

4. Motor according to claim 1, characterized by having two independent rotors, and comprising:
a first and second motor module, each module comprising
a rotor and a stator as defined in claim 1,
a drive shaft integral with the rotor,
the rotor and stator of one module being coaxial to the rotor and stator of the other module,
the drive shaft of a module being coaxial to the drive shaft of the other module and projecting from the motor in the opposite direction to the other shaft,
a circuit for circulating refrigerant fluid,
a cooling component as defined in claim 1, mounted between and in contact with the two modules.

5. Motor according to claim 5, wherein the cooling surface of the cooling component of the first module is placed at a pass-through cavity provided in the cooling component of the second module, and vice versa.

6. Motor according to claim 1, wherein a or each channel in the cooling surface extends from the respective inlet along a path that follows an arc of a circumference having a radius less than that of said stator circumference.

7. Motor according to claim 1, wherein the cooling component comprises two overlapping plates hermetically attached together and extending over a flat surface, the two plates being separated locally by a gap to form a or each said channel.

8. Motor according to claim 1, wherein a or each channel in the cooling surface comprises the sequence of or consists of the sequence of:
a first segment extending from the respective inlet along a path that follows a first arc of a circumference having a radius less than that of said stator circumference,
a second segment that makes a U-turn,
a third segment extending from the second segment to the respective outlet along a path that follows a second arc of a circumference having a radius smaller than that of said circumference and different from the first arc.

9. Motor according to claim 1, wherein the cooling component is mounted on a connecting flange comprising a circular attachment ring having a radius substantially equal to that of said stator circumference, the flange comprising a central portion integral with the circular ring configured to house a rotary encoder.

10. (canceled)

11. Motor according to claim 2, wherein a or each channel in the cooling surface extends from the respective inlet along a path that follows an arc of a circumference having a radius less than that of said stator circumference.

12. Motor according to claim 3, wherein a or each channel in the cooling surface extends from the respective inlet along a path that follows an arc of a circumference having a radius less than that of said stator circumference.

13. Motor according to claim 4, wherein a or each channel in the cooling surface extends from the respective inlet along a path that follows an arc of a circumference having a radius less than that of said stator circumference.

14. Motor according to claim 5, wherein a or each channel in the cooling surface extends from the respective inlet along a path that follows an arc of a circumference having a radius less than that of said stator circumference.

15. Motor according to claim 6, wherein a or each channel in the cooling surface extends from the respective inlet along a path that follows an arc of a circumference having a radius less than that of said stator circumference.

16. Motor according to claim 2, wherein the cooling component comprises two overlapping plates hermetically attached together and extending over a flat surface, the two plates being separated locally by a gap to form a or each said channel.

17. Motor according to claim 3, wherein the cooling component comprises two overlapping plates hermetically attached together and extending over a flat surface, the two plates being separated locally by a gap to form a or each said channel.

18. Motor according to claim 4, wherein the cooling component comprises two overlapping plates hermetically attached together and extending over a flat surface, the two plates being separated locally by a gap to form a or each said channel.

19. Motor according to claim 2, wherein a or each channel in the cooling surface comprises the sequence of or consists of the sequence of:
a first segment extending from the respective inlet along a path that follows a first arc of a circumference having a radius less than that of said stator circumference,
a second segment that makes a U-turn,
a third segment extending from the second segment to the respective outlet along a path that follows a second arc of a circumference having a radius smaller than that of said circumference and different from the first arc.

18. Motor according to claim 3, wherein a or each channel in the cooling surface comprises the sequence of or consists of the sequence of:
a first segment extending from the respective inlet along a path that follows a first arc of a circumference having a radius less than that of said stator circumference,
a second segment that makes a U-turn,
a third segment extending from the second segment to the respective outlet along a path that follows a second arc of a circumference having a radius smaller than that of said circumference and different from the first arc.

19. Motor according to claim 4, wherein a or each channel in the cooling surface comprises the sequence of or consists of the sequence of:
a first segment extending from the respective inlet along a path that follows a first arc of a circumference having a radius less than that of said stator circumference,
a second segment that makes a U-turn,
a third segment extending from the second segment to the respective outlet along a path that follows a second arc of a circumference having a radius smaller than that of said circumference and different from the first arc.
